(19) United States
(12) Patent Application Publication
(10) Pub. No.: US 2012/0234353 A1
(43) Pub. Date: Sep. 20, 2012

(54) AUTOMATED RECEPTACLE CLEANING APPARATUS AND METHOD

(76) Inventors: Patrick John Wiley, Boise, ID (US); James William Joyce, Boise, ID (US)

(21) Appl. No.: 13/426,509

(22) Filed: Mar. 21, 2012

Related U.S. Application Data
(63) Continuation-in-part of application No. 13/299,236, filed on Nov. 17, 2011.
(60) Provisional application No. 61/415,290, filed on Nov. 18, 2010.

(51) Int. Cl. B08B 9/28; B08B 7/04; B08B 9/093; B08B 9/44; B08B 3/02; B08B 3/08

(52) U.S. Cl. 134/10; 134/110; 134/109; 134/111; 134/104.2; 134/23; 134/22.18

(57) ABSTRACT

A self-contained, mobile system for cleaning trash receptacles. The system comprises a water system and a lift system that work in conjunction with each other to provide an automated method for cleaning trash receptacles. The water system acts as a water purification system minimizing waste of the cleaning solution and maximizing efficiency. The system may be adapted to clean multiple trash receptacles sequentially or simultaneously.

### RELATED APPLICATIONS

This application is a continuation-in-part application of co-pending U.S. patent application Ser. No. 13/299,236, filed Nov. 17, 2011, which claims the benefit of co-pending U.S. Provisional Patent Application Ser. No. 61/415,290, filed Nov. 18, 2010, and both of which are incorporated herein by reference.

### BACKGROUND

1. The Field of the Invention

This invention relates to processes for industrial washing, and, more particularly, to cleaning and sterilizing of waste receptacles such as garbage cans, totes, dumpsters, recycling containers and the like.

2. Background

Trash receptacles (bins, totes, carts, dumpsters) used out of doors to collect and transport various waste materials from a residence or business now come in certain relatively standard forms. Such trash receptacles are adapted for mechanical handling by refuse trucks. They are generally cylindrical or rectangular with a lid on a hinge and a bottom that may include wheels.

The types of materials transported in these receptacles may be varied. A residence or business may have multiple bins or receptacles. Often one receptacle is used for combined trash materials considered waste and not easily recyclable, while another receptacle is used for certain types of materials designated for recycling. Moreover, there may be more than one receptacle used for different types of recycling to further separate recyclable materials, i.e., one receptacle for paper recyclables and another receptacle for plastic recyclables.

The relatively standardized forms and materials of trash receptacles were selected for automated processes for gathering and removing the various types of waste. Garbage or refuse trucks that allow for mechanized, even somewhat automated gathering and transport of the various types of waste are well-known fixtures.

Trash receptacles accumulate persistent residues, from liquids to solids, often with associated odors. The process for cleaning trash receptacles at the point of use is not frequently employed and has not advanced in the same manner as the process for gathering and transporting waste materials. Generally, if someone wants clean trash receptacles, the official recommendation is that they clean the trash receptacles themselves, typically with a garden hose, by hand For example, one may spray the inside of the receptacle with a garden hose in an attempt to at least rinse out the bulk of residue inside receptacle. A more determined person may include some sort of scrubbing of the inside of the receptacle with a brush, rag or mop, followed by rinsing the receptacle. Few do so, for a variety of unsavory reasons.

What is needed then, whether recognized or not in the garbage industry, is a mechanized, even automated, non-personal-contact, relatively inexpensive method of cleaning the various trash receptacles. A portable system that could quickly and easily clean trash receptacles would provide a valuable service for improving cleanliness. It would be a further advantage to have a system that can clean multiple trash receptacles sequentially or simultaneously.

### BRIEF SUMMARY OF THE INVENTION

In accordance with the foregoing, certain embodiments of an apparatus and method in accordance with the invention provide a self-contained, automated system for cleaning trash receptacles. A water system and lift system work in conjunction with each other to accomplish this.

The water system may comprise: a tank that contains a cleaning solution; a pump that heats, pressurizes, and sprays the cleaning solution into the receptacles to be cleaned; a collection shroud that collects the cleaning solution after it leaves the receptacles; and a filtering system that prepares the cleaning solution for reuse. The lift system may comprise a lift or arm and linkage system that can engage and move the trash receptacles. The lift system may be a hydraulic system that can move the trash receptacles from their original position, to a positions where they can be cleaned, and back to their original positions.

The water system and the lift system operate in coordination with each other to clean and sterilize the trash receptacles. For example, a mobile apparatus may be mounted on a vehicle to move into position next to a trash receptacle to be cleaned. The lift system may engage the receptacle and then move the receptacle on or near a vehicle into a position to be cleaned. The water system may then dispense the cleaning solution into the receptacle and clean out the inside of the receptacle. The lift system then returns the trash receptacle to its original position. The water system collects, filters, cleans, and reuses the cleaning solution so a minimal amount of cleaning solution is used to clean multiple trash receptacles. This system minimizes use of water, minimizes hauling weight, and minimizes wasted cleaning solution.

One embodiment of the present system cleans a trash receptacle using a multi-stage process. For example, a trash receptacle is sprayed with a washing solution to remove the majority of debris and residue and then sprayed with a cleaning or disinfectant solution to sterilize the receptacle. The respective solutions may be maintained in separate tanks and used independently.

One embodiment of the present system cleans one trash receptacle during a single cycle. One embodiment of the present system cleans multiple trash receptacles during a single cycle. One embodiment of the present system is stationary and the trash receptacles to be cleaned are brought to the cleaning station, cleaned, and then replaced. All embodiments may be used with the various types of trash receptacles used by the majority of residences.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a rear perspective view of one embodiment of a system for cleaning trash receptacles in accordance with the invention with two receptacles in a loading mode;

FIG. 2 is an alternate rear perspective view of the embodiment of FIG. 1;

FIG. 3 is a side elevation view of a primary pump mechanism of a system for cleaning trash receptacles;

FIG. 4 is a front perspective view of a sprayer of a system for cleaning trash receptacles;

FIG. 5 is a front perspective view of a shroud, or collection unit, of a system for cleaning trash receptacles;

FIG. 6 is a front perspective view of a filtering and sterilization unit of a system for cleaning trash receptacles;

FIG. 7 is a rear perspective view of one embodiment of a system for cleaning trash receptacles in accordance with the invention with two receptacles in a loading mode; and

FIG. 8 is a rear perspective view of the embodiment of FIG. 7 with two receptacles in a cleaning mode.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

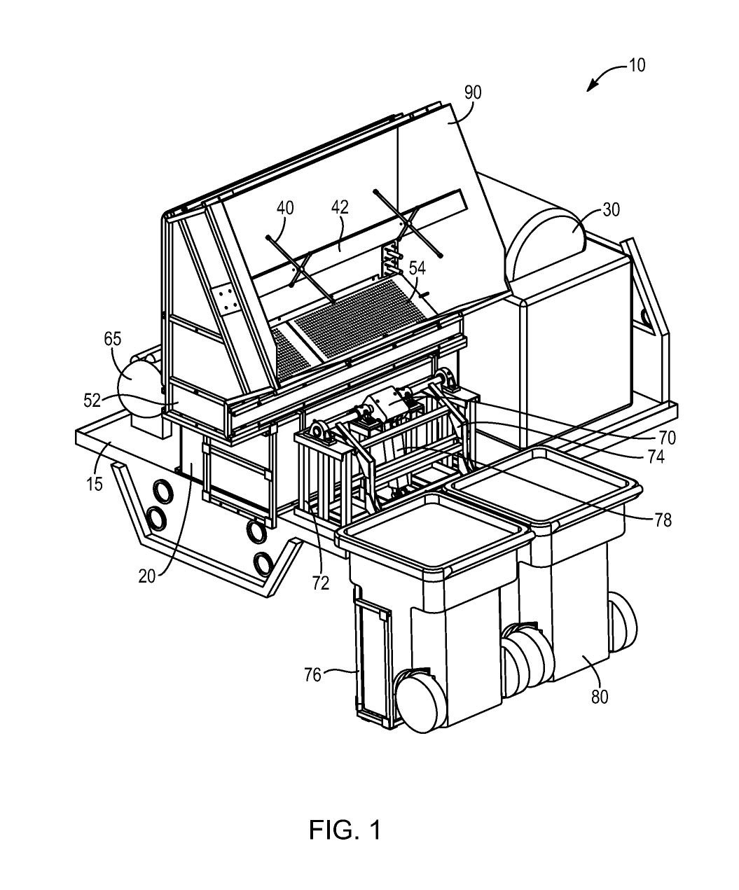

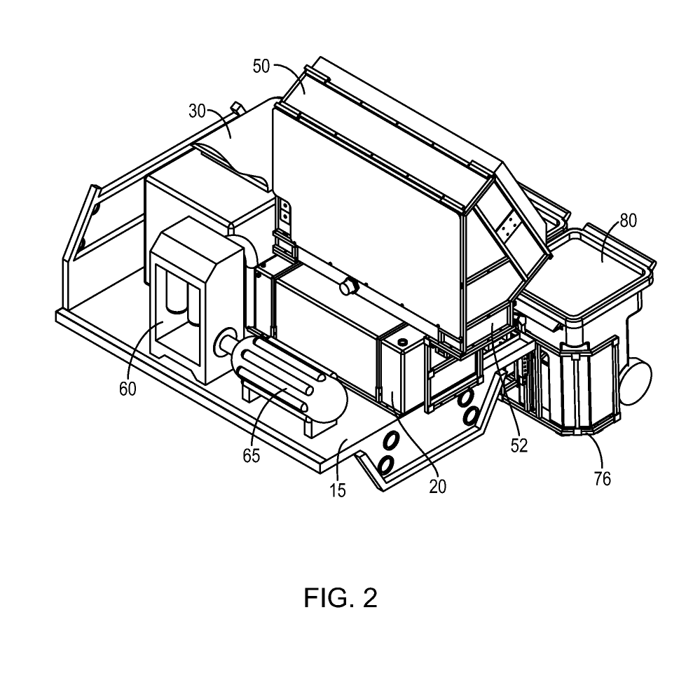

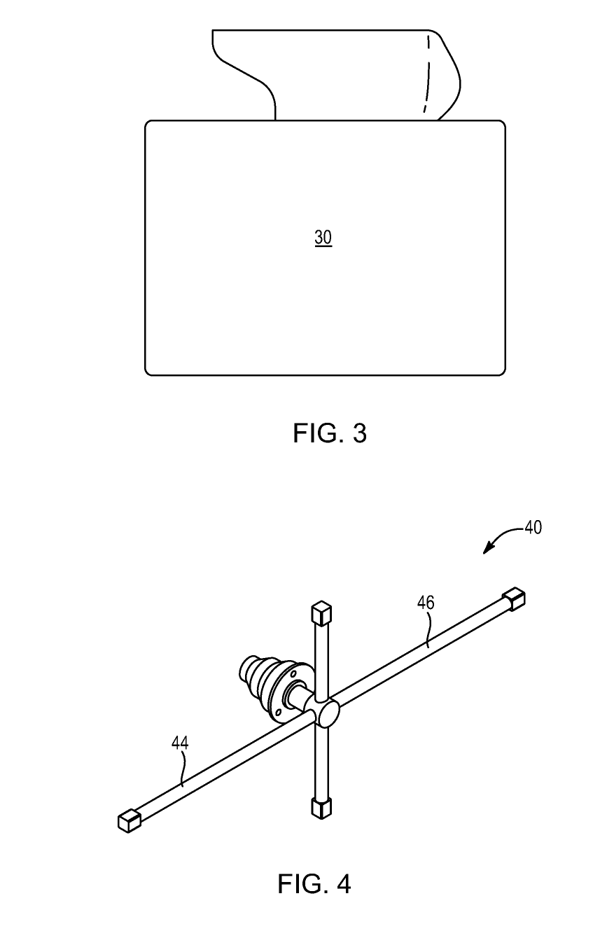

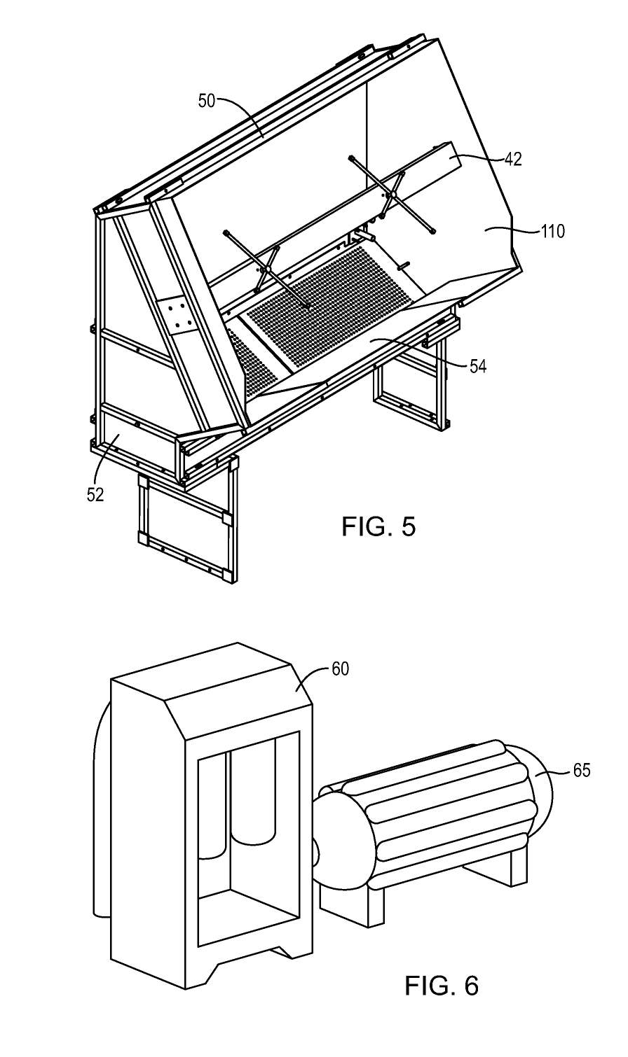

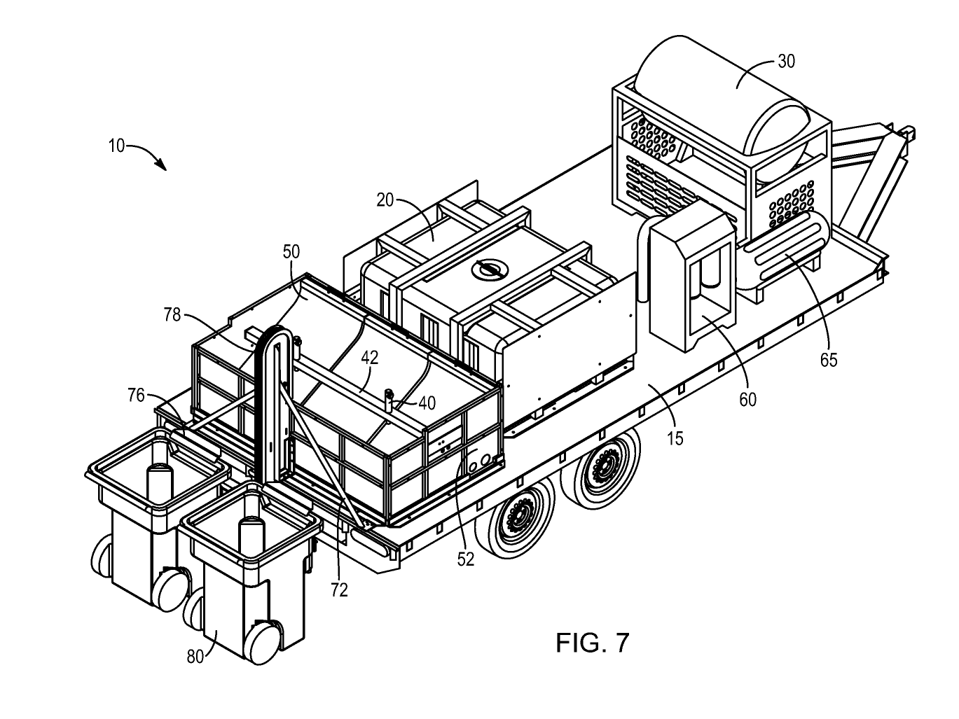

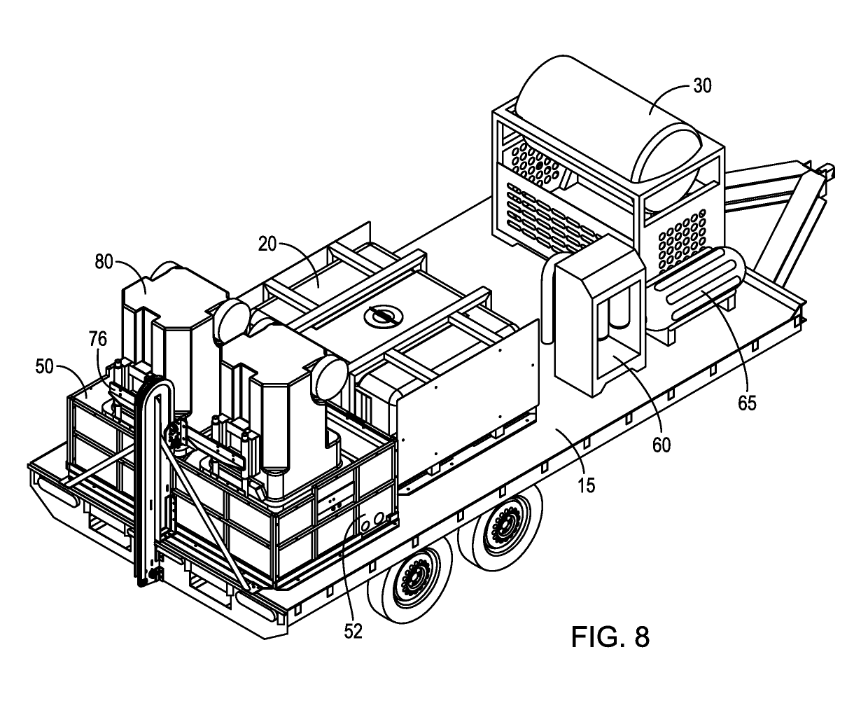

Referring to FIGS. 1-9, an apparatus 10 or system 10 in accordance with the invention may be configured to be self-contained and mobile. The system 10 may be configured to be transported on a flat surface, such as a flat-bed truck (see especially FIGS. 1-2) or a trailer (see especially FIGS. 7-8), or may be configured to be transported by alternate means, such as a regular pick-up truck. The system 10 may also be configured to be stationary.

The system 10 may be described as having a water system and a lift system working in cooperation to clean a receptacle. The water system may be described as facilitating the movement and collection of a cleaning solution used to clean the receptacles. The water system may also include heating, filtering, and sterilizing of the cleaning solution. The lift system may be described as facilitating the positioning of the receptacles through the process of loading, cleaning, and returning the receptacles throughout the cleaning process.

Referring to FIGS. 1-9, the water system may be comprised primarily of a tank 20, a primary pump 30, wands 40, a shroud 50 or collection device, and a filtering system 60. The water system may include additional components to aid in the cleaning and collection process. For example, a heater (not pictured) may be included with the pump 30 to heat the cleaning solution used to clean the receptacles 80. Also, an ultra-violet water sterilization unit 65 may be used to kill bacteria and further sterilize the cleaning solution, especially at moderate (e.g. closer to ambient) temperatures rather than elecated (between pasteurization and boiling) temperatures.

The tank 20 may be of any suitable size and shape, and may be composed of any suitable material, especially non-corroding materials, such as stainless steel or polymers like polyethylene plastic. The tank 20 is the primary location for the cleaning solution used in the cleaning process. In one embodiment, the tank 20 has a square cross-section, as depicted in FIGS. 1, 2, 7 and 8.

However, other cross-sections are likewise extremely suitable, such as a square cross-section tank or an efficient, blow-molded, fitted tank surrounding or fitted between other components. The shape or size of the tank 20 should be such that the system 10 may be self-contained, mobile, and provide enough volume to perform a suitable number of cleaning cycles. The tank 20 contains the cleaning solution to be used in the cleaning process.

The cleaning solution may be any solution suitable for spraying the inside of the receptacles 80. For example and not by way of limitation, the cleaning solution may be water, alone or treated such as by a detergent, disinfecting solution, or both. The disinfecting solution may include any suitable disinfecting agent such as an alcohol, an aldehyde, a phenolic, a quaternary ammonium compound, an oxidizing agent, or the like.

The oxidizing agents may include sodium hypochlorite, chlorine, chlorine dioxide, ozone, lactic acid, acidic electrolyzed water, or the like. Disinfecting solutions are used to provide an extra measure of cleanliness to the receptacles after the cleaning process. Detergents may help free debris and dried liquid residue materials or other residues from the walls of the receptacle to be cleaned. Some materials like ammonia act as both detergents and disinfectants.

The cleaning tank 20 is fluidly connected to the primary pump 30. The primary pump 30 may be any pumping mechanism (e.g. positive flow, non-positive, impeller, diaphragm, centrifugal, etc.) suitable for transferring the cleaning solution from the tank 20 to the wands 40 under suitable pressure. The primary pump 30 should be corrosion resistant, not easily jammed, and also be able to generate enough water pressure to facilitate the mechanical cleaning of the inside of the receptacles 80 by sheer forces and separation pressure generation when the cleaning solution is sprayed through the wands 40 and into the receptacles. Rotary impeller pumps and centrifugal pumps generally appear to be suitable, available, and manufactured in non-reactive polymers. The primary pump 30 may be fluidly connected to a sprayer support 42 such that the cleaning solution may be pumped from the tank 20 through the primary pump 30 and through the sprayer support 42 to the wands 40. In one embodiment, the primary pump is provided as part of a Landa® brand specialized, pressure washer package, such as the Landa® SLX-SLT portable hot water pressure washer.

The primary pump 30 may also include a heater for heating the cleaning solution before it is sprayed into the receptacles 80. The primary pump 30 may heat the cleaning solution to a temperature from about 70 degrees Fahrenheit to about 320 degrees Fahrenheit, and usually from solution approximately 180 to about 310 degrees Fahrenheit. The primary pump 30 may also be capable of delivering the cleaning solution at from about 500 psi to about 4000 psi, and typically from approximately 2500 to about 3500 psi. When heated to such a temperature and delivered at such a pressure, the cleaning solution may be suitable for cleaning receptacles without additional detergents or disinfectants. One such system operates at about 200 degrees Fahrenheit and 3000 psi.

The primary pump 30 may also include a built-in generator for producing the electricity to drive controls and to power the hydraulics for the lift system described hereinafter, or the like.

The wand 40 may be configured in any manner that will facilitate the spraying of the cleaning solution into the receptacle 80 when the receptacle is in the cleaning position, as shown in FIG. 8. For example the wand 40 may extend into the receptacle to a greater or lesser depth, may spin or not spin, and may have any suitable number and direction of jets or sprayers.

The wand 40 may be composed of any suitable material, such as stainless steel or heat tolerant plastic. As shown in FIG. 4, in one embodiment, the wand 40 may include a stem 44 and a sprayer 46 at the end of one or more stems 44. In one embodiment, a Gamajet IX™, which is capable of providing 360 degree impingement of a receptacle may act as a sprayer 46.

The system 10 may be configured to have one wand 40 or to have multiple wands 40. The wands 40 may be configured like wands that include jets, small orifices or apertures at each end of the stems 44, or at each end of the stems 44 and along the shaft of the stems 44. In another embodiment, the wands 40 may be configured to have a Gamajet IX™ sprayer 46 at each end of the stems 44.

The wands 40 may be oriented such that the sprayers 46 may be attached to a sprayer support 42 in fluid connection with the primary pump 30. The wands 40 may be attached to the sprayer support 42 at an approximate midpoint of the wands 40. The wands 40 may begin to spin when the cleaning solution is being pumped through them. The wands 40 may be configured to spin near the opening of the receptacles 80 when the receptacles are in the cleaning position. Alternatively, or in addition, the wands 40 may be configured to spin and extend a certain distance into the receptacles 80 when the receptacles are in the cleaning position. Alternatively, or in addition, the wands 40 may spin at a slower, controlled rate, while the sprayers 46 spray cleaning solution on virtually the entire inside surface of the receptacle 80 later in the cleaning cycle.

In one embodiment, consistent with FIGS. 1, 2, 7, and 8, a cover or shroud 50 may be positioned around the opening of the receptacles 80 when the receptacles are in the cleaning position, as shown more specifically in FIG. 5. The shroud 50 may be a thin sheet of material shaped to cover or enclose all or a portion of the area around the opening of the receptacles 80 when the receptacles are in the cleaning position.

A benefit of the shroud 50 is to help arrest splashing back of the cleaning solution used during the cleaning process when the cleaning solution is forcefully directed or re-directed toward the collection foot 52 and may splash back as a result. The shroud 50 helps to increase the collection of the cleaning solution and to make sure cleaning solution does not spill onto the area surrounding the system 10 during the cleaning process.

The collection foot 52 may be considered the main structure or area where cleaning solution is collected after it is sprayed into the receptacles 80. The collection foot 52 has an opening positioned proximate to the opening for any receptacle 80 in the cleaning position, as shown more particularly in FIG. 8. The collection foot 52 is a temporary holding position for the cleaning solution before the cleaning solution moves to a filtering system. The collection foot 52 does not need to be capable of holding a large amount of cleaning solution. Generally, the collection foot 52 will be able to contain the cleaning solution used to clean the receptacles 80 during approximately 2-3 cleaning cycles, and maybe drained back more often.

In one embodiment and as pictured in FIGS. 1 and 5, a shroud 50 may also include a screen 54. The screen 54 may be a thin sheet of material with suitably sized sieve holes positioned to separate debris from the cleaning solution after the cleaning solution is sprayed into a receptacle 80, but before the cleaning solution enters the collection foot 52. The screen 54 may be composed of any suitable material, such as stainless-steel, PVC, polyethylene or other plastic, or the like. In one embodiment, the screen 54 is positioned between the collection foot 52 and the opening of the receptacle 80 when the receptacle is in the cleaning position.

In one embodiment, the screen 54 may be positioned at an angle. The angle may be any suitable angle that allows the cleaning solution to flow past the screen and facilitates any debris from the receptacle 80 sliding or falling from the screen 54 into a trough at the bottom of the screen 54. The trough may simply be the location formed where the screen 54 connects to the collection foot 52, or may be rounded to collect even more debris.

In one embodiment, a vacuum source may be used to help pull cleaning solution past the screen 54 into the collection foot 52. Additionally, or in an alternative embodiment, a wiper or similar structure may slide across the outside surface of the screen 54 to clean debris off the screen 54 and into the trough. Alternatively, debris may be cleaned off the screen 54 or out of the trough manually, hydraulically (by water pressure), or a combination of any of the foregoing.

The collection foot 52 is fluidly connected to the filtering system 60. Cleaning solution contained in the collection foot 52 may be pumped or otherwise transferred through the filtering system 60. The filtering system 60 may be any suitable system capable of filtering the recycled cleaning solution sufficiently to reuse the cleaning solution. The filtering system 60 may be comprised of multiple filters used to filter the cleaning solution in sequential stages. Each stage may collect solids and remove them periodically or continuously.

In one embodiment, the filtering system 60 may include having the cleaning solution filtered through a bag filter after the cleaning solution exits the collection foot 52. The bag filter may be a polypropylene filter like that available from Duda Diesel LLC. Any suitable, similar bag filter may be used.

In one embodiment, the filtering system 60 may include having the cleaning solution filtered through a pleated paper filter after the cleaning solution is filtered by the bag filter. The pleated paper filter may be a Unicel™ Flow-Max™ filter cartridge. Any suitable, similar pleated paper filter may be used.

In one embodiment, the filtering system 60 may include having the cleaning solution filtered through a charcoal filter after the cleaning solution is filtered by the pleated paper filter. The charcoal filter may be a Filtrex™ Greenblock Carbon FX20CL2 filter. Any suitable, similar charcoal filter may be used.

A filtering system 60 that incorporates a bag filter, a pleated paper filter, and a charcoal filter in succession is available from Landa®. Such a pre-assembled filtering system 60 may also be used.

In one embodiment, the filtering system 60 is in fluid connection with an ultra-violet water sterilization unit 65. The cleaning solution may also be passed through an ultra-violet water sterilization unit, or UV unit 65, after the cleaning solution has been filtered by the filtering system 60. The UV unit 65 may be an Aqua UV™ ultra-violet water sterilization unit. Any suitable, similar ultra-violet water sterilization unit of suitable capacity and effectiveness may be used.

The use of a UV unit 65 to further sterilize the recycled cleaning solution may become more important in considering thermal energy use. It has been shown that recycled cleaning solution that has only been filtered through a filtering system 60 as described herein may still contain a substantial amount of bacteria. However, recycled cleaning solution that has been filtered through a filtering system 60 and then sterilized with a suitable UV unit 65 is substantially free of bacteria. It has been shown that recycled cleaning solution filtered and sterilized with a UV unit is more than 95% free of bacteria and approximately 99.7% free of bacterial. The use of a UV unit 65 as described herein to sterilize the recycled cleaning solution virtually eliminates bacteria from the cleaning solution. Moreover, this permits the use of less thermal energy (heating) in the water. Mechanical energy (pressure) is less expensive for cleaning.

Thus, substantially cleaner cleaning solution is used to clean the receptacles. This use of a UV unit 65 makes it possible to use cleaning solution that is not heated to pasteurization temperatures to clean the receptacles.

After the cleaning solution has passed through the filtering system 60, it may be returned to the tank 20 for reuse in the cleaning process. Alternatively, or in addition, the cleaning solution may be passed through the UV unit 65 and returned to the tank 20 for reuse in the cleaning process.

The lift system 70 may include a lift or arm 74. The arm 74 may be controlled by any system that enables the arm 74 to lift a receptacle 80 off the ground. For example, the arm 74 may include any structure suitable for engaging a receptacle 80, or lift engagement 76, as well as support structure 72 suitable for stabilizing the lift system 70 on the platform 15. The arm 74 may be controlled by a hydraulic system 78 that lifts the engaged receptacle 80 from an original position on the ground to a cleaning position, as shown more specifically in FIGS. 1, 7, and 8.

The hydraulic system 78 may include a piston that extends and contracts to move the arm 74, as in FIG. 1. The hydraulic system 78 may include a track or chain or the like as a conveyor that lifts and inverts a receptacle along a specific, predetermined path, which may be complex or basic in direction and distance, as in FIGS. 7 and 8. The support structure 72 for the hydraulic system 78 can likewise be adjusted to accommodate the specific hydraulic system 78 used. The arm 74 may then return the receptacle 80 to the original position after the cleaning process has been completed.

In one embodiment, the lift engagement 76 may be configured with a rack or shelf that engages the receptacle 80 from the bottom. In another embodiment, the lift engagement may be configured like a clamp, or pincer, or fork that engages the receptacle around the approximate middle of the receptacle. In another embodiment, the arm 74 may be configured to removably attach to a bracket like, engagement portion of the receptacle 80.

The method or cleaning process may include various steps depending on the configuration of the system 10. In one embodiment, a typical cleaning process or cleaning cycle may include positioning the system 10 to engage a receptacle 80 to be cleaned. The lift engagement 76 from the lift system 70 may then engage the receptacle 80 so the receptacle 80 may be moved from its original position on the ground to a cleaning position.

Once in the cleaning position, the receptacle 80 may be cleaned by pressure driving holes through residues and lifting the residues by developing pressure there behind. Lateral shear forces of the flows parallel to walls carry the residues away. As the system 10 sprays cleaning solution through the wands 40 the solution carries residues back into the receptacle 80. The cleaning solution may then be collected to be recycled and used again later. The receptacle 80 may then be returned to its original position on the ground. The system 10 may then move on to repeat this process with another receptacle.

This cleaning process may be adjusted depending on the configuration of the system 10. For example, the system 10 or primary pump 30 may include a heater that heats and pressurizes the cleaning solution before it is sprayed into the receptacle 80. As another example, the system 10 may include a filtering system 60 that filters the cleaning solution after it is collected and before it is recycled or transferred to the tank 20 to be reused. In another example, the system 10 may include a UV unit to sterilize the cleaning solution before it is recycled or transferred to the tank 20 to be reused. The remainder of the cleaning process may be essentially unchanged by the addition of either or both of these steps of heating and filtering.

The receptacle 80 to be cleaned may be any receptacle 80 of suitable size and shape that may be engaged by the system 10. The receptacle 80 may be a traditional trash can, a dumpster, or a plastic bin or cart style with a lid on a hinge and wheels on its base. The receptacle 80 may be made of any suitable material. The receptacle 80 may be used to contain any type of waste material, such as recyclable, non-recyclable, wet, or dry waste.

While the system 10 may be configured to be mobile, the system 10 may also be configured to be stationary and still operate in much the same way. A stationary system 10 may include all the primary components described above and operate in much the same manner. In a stationary embodiment, the platform 15 or bed of the system 10 may be the ground or any suitable built-up platform.

Any tank or pump used in a stationary system may be enlarged or otherwise modified to enable more repetitions of the cleaning process, or even provide a virtually continual supply of cleaning materials. One difference between a mobile system 10 and a stationary system 10 is that someone wanting to clean a receptacle 80 using the mobile system 10 may position the receptacle 80 to be cleaned where the lift engagement 76 may engage the receptacle 80 such as at a curb. A stationary system 10 may have conveyors feed receptacles 80 to it. The receptacle position then corresponds to the original position described above. Again, the system 10 may be configured to clean one receptacle during a given cleaning cycle or multiple receptacles during a cleaning cycle.

The stationary system 10 may or may not include a heater for heating the cleaning solution used in the cleaning process. UV light may perform all sterilization. Hear increases chemical processes, so a temperature above 100 degrees Fahrenheit is preferred, and over 140 degrees is recommended. The stationary system 10 may or may not include a filtering system for filtering the cleaning solution as it is prepared to be reused and transferred to the tank 20.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. An apparatus for cleaning waste receptacles, the apparatus comprising:
a lift system positioned to engage a receptacle at an original position and capable of moving the receptacle into a cleaning position and back to the original position;
a tank fluidly connected to a primary pump;
the pressurizing pump fluidly connected to wands;
the wands positioned to spray a cleaning solution into the receptacle while in the cleaning position;
a collection foot positioned to collect the cleaning solution after use; and
the collection foot fluidly connected to a filtering system to filter the cleaning solution collected; and
the filtering system fluidly connected to the tank allowing the transfer of the cleaning solution from the filtering system to the tank where the cleaning solution may be reused.

2. The apparatus of claim 1, further comprising:
an ultra-violet water sterilization unit fluidly connected between the filtering system and tank to sterilize the cleaning solution wherein the cleaning solution transferred from the filtering system to the tank is substantially free of bacteria.

3. The apparatus of claim 1, further comprising:
a shroud positioned around the collection foot to capture the used cleaning solution and direct the cleaning solution into the collection foot.

4. The apparatus of claim 1, further comprising a screen positioned between the collection foot and the opening of the receptacle when the receptacle is in the cleaning position.

5. The apparatus of claim 1, wherein the cleaning solution is a disinfecting solution.

6. The apparatus of claim 5, wherein the cleaning solution includes a disinfecting agent selected from the group consisting of an alcohol, an aldehyde, a phenolic, a quaternary ammonium compound, and an oxidizing agent.

7. The apparatus of claim 1, wherein the wands extend from a first position to a second position, and the second position positions the wands at least six inches inside the receptacle.

8. The apparatus of claim 1, wherein the lift system can engage and move more than one receptacle.

9. The apparatus of claim 8, further comprising:
at least two wands, each cleaning a receptacle simultaneously.

10. A method for automated cleaning of receptacles, the method comprising:
selecting a receptacle to be cleaned;
operating a hydraulic lift system capable of engaging and moving the receptacle from an original position to a cleaning position and back to the original position;
engaging the receptacle;
moving the receptacle into the cleaning position;
spraying the inside of the receptacle with a cleaning solution;
collecting a residual of the cleaning solution;
recycling the residual cleaning solution to be used again; and
replacing the receptacle to the original position.

11. The method of claim 10, further comprising:
filtering the residual cleaning solution after collecting any residual cleaning solution.

12. The method of claim 11, further comprising:
sterilizing the cleaning solution with an ultra-violet water sterilization unit after filtering the residual cleaning solution such that the residual cleaning solution is substantially free of bacteria.

13. The method of claim 12 wherein the residual cleaning solution is over 99% free of bacteria.

14. The method of claim 10, further comprising:
heating and pressurizing the cleaning solution before spraying the inside of the receptacle.

15. The method of claim 14 wherein the cleaning solution includes a disinfecting agent selected from the group consisting of an alcohol, an aldehyde, a phenolic, a quaternary ammonium compound, or an oxidizing agent.

16. A method for automated cleaning of multiple receptacles, the method comprising:
providing at least two receptacles to be cleaned;
actuating a hydraulic lift system moving the receptacles from an original position to a cleaning position and back to the original position;
capturing the receptacles simultaneously;
moving the receptacles into the cleaning position;
spraying the inside of the receptacles with a cleaning solution;
collecting a residual of the cleaning solution;
recycling the residual cleaning solution to be used again; and
replacing the receptacles to the original position.

17. The method of claim 16, further comprising:
filtering the residual cleaning solution after collecting any residual cleaning solution.

18. The method of claim 17, further comprising:
sterilizing the cleaning solution with an ultra-violet light after filtering the residual cleaning solution such that the residual cleaning solution is substantially free of bacteria.

19. The method of claim 18 wherein the residual cleaning solution is over 99% free of bacteria.

20. The method of claim 16, further comprising:
heating and pressurizing the cleaning solution before spraying the inside of the receptacle with the cleaning solution.
